(19) United States
(12) Patent Application Publication
(10) Pub. No.: US 2026/0025262 A1
(43) Pub. Date: Jan. 22, 2026

(54) DATA PROCESSING

(71) Applicant: MASHANG CONSUMER FINANCE CO., LTD., Chongqing (CN)

(72) Inventors: Ling TANG, Chongqing (CN); Hui DAI, Chongqing (CN)

(73) Assignee: MASHANG CONSUMER FINANCE CO., LTD., Chongqing (CN)

(21) Appl. No.: 19/263,350

(22) Filed: Jul. 8, 2025

(30) Foreign Application Priority Data
Jul. 16, 2024 (CN) 202410955975.3

(51) Int. Cl. H04L 9/08

(52) U.S. Cl. CPC H04L 9/0825

(57) ABSTRACT

A data processing method includes: generating respective private key information of M participants; performing a shard operation on the respective private key information of the M participants according to a predetermined shard operation protocol to obtain key information; encrypting plaintext data of each of the M participants using the key information to obtain respective ciphertext data of the M participants; and performing computation on the respective ciphertext data of the M participants to obtain a data computation result for the M participants.

### CROSS-REFERENCE TO RELATED APPLICATION

This application claims priority to and the benefit of Chinese Patent Application No. 202410955975.3, filed on Jul. 16, 2024, the disclosure of which is incorporated herein by reference in its entirety.

### TECHNICAL FIELD

The present disclosure relates to data processing technologies, and more particularly to data processing methods and related products.

### BACKGROUND

In terms of multi-party data computation, secure computation of data is very important. For example, with the private set union (PSU) operation, a union of multi-party data can be securely computed with no data of the intersection part leaked, so that the multiple parties could input private data of respective sets and perform specific set operations. Thus, the PSU operation may achieve a data circulation mode in which data is available but invisible, and is a key cryptographic technology taking both data circulation and privacy protection into account.

### SUMMARY

According to some embodiments of the present disclosure, a data processing method includes: generating respective private key information of M participants, where M is an integer greater than 1; performing a shard operation on the respective private key information of the M participants according to a predetermined shard operation protocol to obtain key information; encrypting plaintext data of each of the M participants using the key information to obtain respective ciphertext data of the M participants; and performing computation on the respective ciphertext data of the M participants to obtain a data computation result for the M participants.

According to some embodiments of the present disclosure, an electronic device includes a processor and a memory storing a computer program executable by the processor to perform the above data processing method.

According to some embodiments of the present disclosure, a non-transitory computer-readable storage medium stores a computer program executable by a processor to perform the above data processing method.

According to some embodiments of the present disclosure, a computer program product includes a computer program executable by a processor to perform the above data processing method.

### BRIEF DESCRIPTION OF THE DRAWINGS

FIG. 1 is a schematic flowchart of an example of a data processing method according to some embodiments of the present disclosure.

FIG. 2 is a schematic diagram of computation of private key shard products according to some embodiments of the present disclosure.

FIG. 3 is a schematic flowchart of another example of a data processing method according to some embodiments of the present disclosure.

FIG. 4 is a schematic flowchart of yet another example of a data processing method according to some embodiments of the present disclosure.

FIG. 5 is a schematic block diagram of a data processing apparatus according to some embodiments of the present disclosure.

FIG. 6 is a schematic block diagram of an electronic device according to some embodiments of the present disclosure.

### DETAILED DESCRIPTION

Some embodiments of the present disclosure will be described in detail below with reference to the accompanying drawings. The embodiments are described for illustrative purposes only and are not intended to limit the present disclosure.

In multi-party data computation, the data privacy for each participant is important. In the related art, a common method for computing data includes: generating private key information for each participant, and encrypting the same plaintext data by using the private key information for respective participants. For example, a first participant encrypts plaintext data thereof by using the private key information of the first participant to obtain a first ciphertext, a first ciphertext is sent to a second participant, the second participant encrypts the first ciphertext by using the private key information for the second participant to obtain a second ciphertext and then sends the second ciphertext to a third participant, and the third participant encrypts the second ciphertext by using the private key information for the third participant, and this iterative encryption continues until all participants have encrypted the same plaintext data respectively by using the private key information for the respective participants, to obtain the ciphertext data of each participant and perform computation on the ciphertext data of all participants. This method is limited to situations where the number of participants is less (e.g., only two or three participants).

As the data scale increases and the data of the participant increases, encryption and computational efficiency will decrease significantly. Moreover, the above encryption method is relatively simple, and the data security of the participant cannot be ensured. In the data processing method according to some embodiments of the present disclosure, the private key information of each participant is generated, the shard operation is performed on the private key information of M participants (M is the number of participants) according to a preset shard operation protocol to obtain key information, the plaintext data of each of the M participants is encrypted by using the key information to obtain ciphertext data of each of the M participants, and the pieces of ciphertext data of the M participants are computed to obtain a data computation result for the M participants. Since the key information is obtained by performing the shard operation on the private key information of the M participants, the generation of the key information requires the participation of the M participants (that is, all participants), which not only increases the complexity of the key information itself, but also makes decryption of the ciphertext data also require the common participation of the participants, thereby increasing the difficulty of cracking the ciphertext data. Even if the data computation result has been known, it is difficult for one of the participants to infer the plaintext data of other participants from the data computation result without key information for decryption, thereby ensuring the security of the plaintext data of each participant.

The data processing method according to some embodiments of the present disclosure may be executed by an electronic device, or may be executed by software installed in the electronic device. In an embodiment, the electronic device may be a terminal device or a server device. The terminal device may include a smartphone, a notebook computer, an intelligent wearable device, an in-vehicle terminal, and the like. The server device may include an independent physical server, a server cluster including a plurality of servers, or a cloud server capable of performing cloud computing.

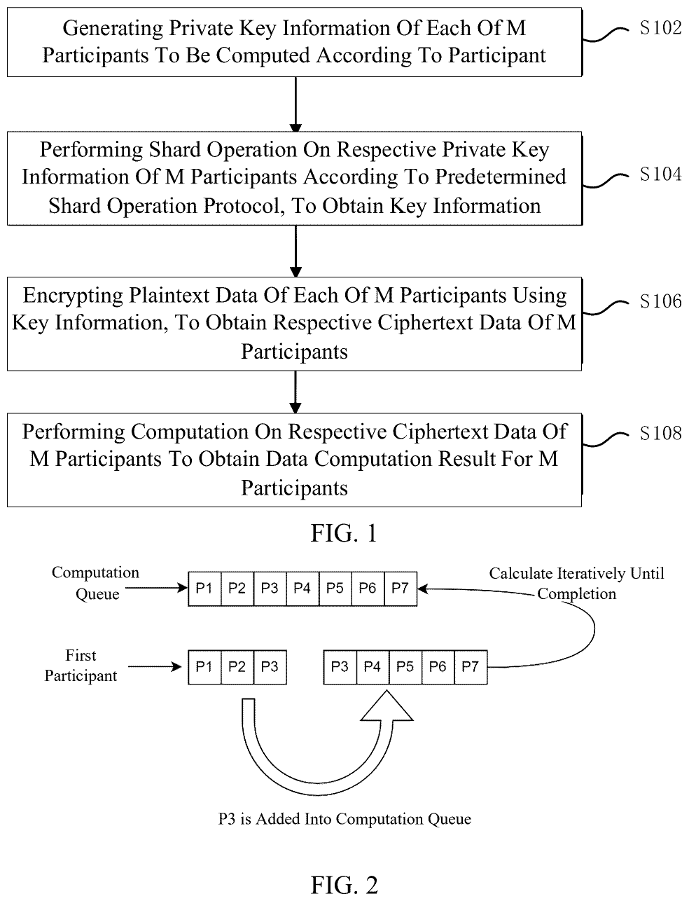

FIG. 1 is a schematic flowchart of an example of a data processing method according to some embodiments of the present disclosure. As shown in FIG. 1, the data processing method includes Step S102 to Step S108.

At Step S102, respective private key information of M participants is generated, where M is an integer greater than 1.

When generating the private key information of each participant, a private key parameter of the private key information may be first determined, and the private key parameter may include at least one of a private key length, a private key modulus, a primitive root, a random blinding factor, a large prime number, and the like. The private key length is used to constrain the length of the private key information, for example, four bits in length. The private key modulus is used to constrain the range of the private key information, for example, if the private key modulus is 1024, the generated private key information should not exceed 1024.

The private key information may be generated locally by each participant, and after each participant generates the private key information locally, the private key information is stored locally without leaking to other participants, thereby ensuring confidentiality of the respective private key information.

In some examples, the private key parameter may be preset so that the participant may generate the private key information based on the preset private key parameter. In some examples, the private key parameter may be generated by a third party, the generated private key parameter is transmitted by the third party to respective participants, and each participant generates the private key information based on the private key parameter transmitted by the third party.

For example, the third party generates the following private key parameters: a private key modulus p, a primitive root g, a random blinding factor r, and a large prime numbers, and transmits these private key parameters to the participants, and each participant generates private key information thereof based on the private key parameters according to the following formula:

$${RND}_{i} = r and ( bit ) \% p \qquad {K}_{i} = {g}^{{RND}_{i}} mod p ,$$

where RNDᵢ represents a random number corresponding to the i-th participant; bit represents the number of bits of the random number (usually 128 or more bits); and Kᵢ represents private key information of the i-th participant. In some examples, the third party may generate only part of the private key parameters, for example, only the private key modulus, and then send the private key module to the participants, and other private key parameters are generated locally by the participants.

At Step S104, a shard operation is performed on the respective private key information of the M participants according to a predetermined shard operation protocol to obtain key information.

In some examples, the shard operation protocol may include a secure multiplication operation protocol. After the key information is obtained according to the secure multiplication operation protocol, the plaintext data of each participant will be encrypted by using a threshold encryption algorithm. The threshold encryption algorithm means that at least n participants are required to participate in decrypting the operation result data under the condition that n participants participate in the encryption.

At Step S106, plaintext data of each of the M participants is encrypted using the key information, to obtain respective ciphertext data of the M participants.

In some examples, after the key information is determined, the key information and the plaintext data may be used as input of a preset encryption algorithm, and the ciphertext data may be obtained by performing computation on the key information and the plaintext data according to the preset encryption algorithm. The preset encryption algorithm may be any encryption algorithm, for example, Data Encryption Algorithm (DEA), Triple Data Encryption Algorithm (TDEA, 3DES), or Advanced Encryption Standard (AES).

At Step S108, computation is performed on the respective ciphertext data of the M participants to obtain a data computation result for the M participants.

In some examples, the performing of the computation on the ciphertext data of the M participants may include: performing a set operation on the ciphertext data of the M participants. The set operation means that the ciphertext data of each of M participants is taken as a set to obtain M sets and computation is performed on the M sets. The set operation may include a union operation, a set-intersection operation, and the like. When Step S106 to Step S108 are executed in the present embodiment, each participant may encrypt its plaintext data locally to obtain ciphertext data of the each participant, and then all of the participants transmit their ciphertext data to a third party, and the third party performs computation on the ciphertext data of all participants. Since the third party obtains only the ciphertext data of the participants when performing the above computation and the plaintext data is not known to the third party, it is possible to ensure that the plaintext data of each participant is not leaked to other participants.

In some embodiments of the present disclosure, the private key information of each participant is generated, the shard operation is performed on the private key information of M participants (M is the number of participants) according to a preset shard operation protocol to obtain key information, the plaintext data of each of the M participants is encrypted by using the key information to obtain ciphertext data of each of the M participants, and the ciphertext data of the M participants is computed to obtain a data computation result for the M participants. Since the key information is obtained by performing the shard operation on the private key information of the M participants, the generation of the key information requires the participation of the M participants (that is, all participants), which not only increases the complexity of the key information itself, but also makes decryption of the ciphertext data also requires collaborative decryption from all participants, thereby increasing the difficulty of cracking the ciphertext data. Even if the data computation result has been known, it is difficult for one of the participants to infer the plaintext data of other participants from the data computation result without the key information, thereby ensuring the security of the plaintext data of each participant.

In an embodiment, the shard operation protocol includes a secure multiplication operation protocol. When the shard operation is performed on the private key information of the M participants according to the preset shard operation protocol, a secure multiplication operation may be performed on the private key information of the M participants according to the secure multiplication operation protocol to obtain respective private key shard products for the M participants, and then the key information is determined based on the respective private key shard products for the M participants.

The obtaining of the private key shard product for the M participants according to the secure multiplication operation protocol is described in detail below.

In an embodiment, the obtaining of the private key shard products may include the following steps: constructing a computation queue of the M participants, where in the computation queue of the M participants, the order of the participants is not limited, or, the M participants are randomly sorted and the sorted M participants form the computation queue; and for the computation queue, iteratively performing the following Step A1 to Step A3 until the private key shard product for a last one of the participants in the computation queue is determined.

At Step A1, first N participants are extracted from the computation queue as first participants to be computed, and a private key shard product for the N first participants is computed based on the private key information of the N first participants.

Where N is an integer greater than 1. The value of N is not limited. In some examples, N may be chosen as an integer greater than 2 to ensure data security. The reason is that if N is equal to two, that is, two participants perform the secure multiplication operation, one of the participants may easily reverse-derive the private key information of the other of the participants. For example, for one of the participants, the private key information of the other of the participants may be obtained by dividing the final key information by a private key information of the one of the participants, thereby causing the leakage of the private key information of the other of the participants.

At Step A2, one first participant selected from the N first participants is added to the head of a remaining portion of the computation queue excluding the N first participants to obtain an updated computation queue; and the private key information of the one first participant located at the head of the updated computation queue is updated with the private key shard products for the N first participants.

In some examples, the last one of the N first participants is added to the head of the remaining portion of the computation queue, to obtain an updated computation queue. The private key shard product for the N first participants is determined as the private key information of the first participant located at the head of the updated computation queue.

At Step A3, a private key shard product for first N participants of the updated computation queue is computed based on the updated computation queue.

For example, the participants includes {P1, P2, P3, P4, P5, P6, P7}, N=3. In each iterative, three ones of the participants commonly perform a secure three-party multiplication operation protocol. As shown in FIG. 2, the participants are ordered as P1, P2, P3, P4, P5, P6, and P7 in the computation queue. First, the first three participants, namely, P1, P2, P3, in the computation queue are selected as the first participants. After the private key shard product for the third first participant is computed based on the private key information of respective ones of the three first participants P1, P2 and P3, the first participant P3 is added to the head of the remaining portion of the computation queue to obtain the following updated computation queue: P3, P4, P5, P6 and P7. The computed private key shard product for the third first participant is then used to replace the initial private key information of the first participant P3. Thereafter, new first three participants, namely, P3, P4, P5, are selected from the above updated computation queue as new first participants. The computation of the private key shard product for the new first participants is performed in a way same as that of the three first participants P1, P2, P3. The above process is repeated until the private key shard product for the last participant (i.e., participant P7) is obtained.

In some examples, after computing the private key shard product for the last participant in the computation queue, it may be determined that the private key shard product for the last participant is key information.

In an embodiment, Step A1 may be implemented by Step B1 to Step B4 as follows.

At Step B1, an element set of each first participant is generated, and an element share product for the first participant is computed, where the element set includes at least one element.

The first participant includes P1, P2, and P3 as examples. The element set of each first participant is locally generated at the first participant, the element set generated by the first participant P1 is denoted by (a₁, b₁, c₁), the element set generated by the first participant P2 is denoted by (a₂, b₂, c₂), and the element set generated by the first participant P3 is denoted by (a₃, b₃, c₃). a₁, b₁, c₁ are elements in the element set of the first participant P1, a₂, b₂, c₂ are elements in the element set of the first participant P2, and a₃, b₃, c₃ are elements in the element set of the first participant P3.

In some examples, the generating of the element set for each first participant may include: generating a master element set (a, b, c) and then performing sharding on a, b, and c, respectively. The sharding is performed on a to obtain a₁, a₂, and a₃, where a₁+a₂+a₃=a. Similarly, the sharding is performed on b to obtain b₁, b₂, and b₃, where b₁+b₂+b₃=b. The sharding is performed on c to obtain c₁, c₂, and c₃, where c₁+c₂+c₃=c. Further, the elements obtained in the sharding are assigned to respective ones of the first participants. For example, the elements a₁, b₁, c₁ are assigned to the first participant P1, the elements a₂, b₂, c₂ are assigned to the first participant P2, and the elements a₃, b₃, c₃ are assigned to the first participant P3.

At Step B2, the private key information of each first participant is sharded to obtain private key shards of the first participant.

The number of private key shards for each first participant is the same as the number of the first participants participating in the computation. Assume that the private key information of the first participant P1 is X, the private key information of the first participant P2 is Y, and the private key information of the first participant P3 is Z. The sharding is performed on the private key information X of the first participant P1, to obtain the private key shards (x₁, x₂, x₃) of the first participant P1, where x₁+x₂+x₃=X. The sharding is performed on the private key information Y of the first participant P2, to obtain the private key shards (y₁, y₂, y₃) of the first participant P2, where y₁+y₂+y₃=Y. The sharding is performed on the private key information Z of the first participant P3, to obtain the private key shards (z₁, z₂, z₃) of the first participant P3, where z₁+z₂+z₃=Z.

At Step B3, encrypted elements, private key shards and blinded private key shards of each second first participant are obtained, where the first participants include the first first participant in the current computation and one or more second first participants of the N first participants excluding the first first participant.

The encrypted element of each second first participant is obtained by encrypting its element in the element set by using a private key of the second first participant, and the blinded private key shard of the second first participant is obtained by binding the private key shard thereof by using the element of the second first participant. The second first participant is a portion of the N first participants other than the first first participant in the current computation. For example, the first participant includes P1, P2, and P3. If the first first participant in the current computation is P1, i.e., the private key shard product for the first first participant P1 is currently being computed, the second first participant includes the first participants P2 and P3.

At this step, when the first first participant obtains the encrypted element and the blinded private key shard for the second first participant, the first first participant shares its own encrypted element and the blinded private key shard to the second first participant, so that the second first participant performs computation for obtaining the private key shard product thereof.

The private key is a key generated locally by each participant and not publicly available and the private key is used to encrypt its own elements. The private key may be homomorphic encrypted public key and private key. When the first first participant exchanges the data with the second first participant, the first first participant exchanges the encrypted elements, rather than the elements themselves, with the second first participant, to ensure that the elements of the first and second first participants are not leaked to each other.

Similarly, after each first first participant generates the private key shards thereof, the first participant retains one of the private key shards and shares the remaining of the private key shards respectively to the second first participants. For example, after the first participant P1 generates the private key shards (x₁, x₂, x₃) thereof, the first participant P1 itself retains the private key shard x₁ and shares the private key shard x₂ to the first participant P2 and the private key shard x₃ to the first participant P3. After the first participant P2 generates the private key shards (y₁, y₂, y₃) thereof, the first participant P2 itself retains the private key shard y₂ and shares the private key shard y₁ to the first participant P1 and the private key shard y₃ to the first participant P3. After the first participant P3 generates the private key shards (21, 22, 23) thereof, the first participant P3 itself retains the private key shard 23 and shares the private key shard 21 to the first participant P1 and the private key shard 23 to the first participant P2. Thus, the first participant P1 has the following information: X, x₁, y₁, z₁, a₁, b₁, c₁. The first participant P2 has the following information: Y, x₂, y₂, z₂, a₂, b₂, c₂. The first participant P3 has the following information: Z, x₃, y₃, z₃, a₃, b₃, c₃.

Take the example where the first participant P1 determines its encrypted element and blinded private key shard. The first participant P1 has an element set (a₁, b₁, c₁), and the private key m₁. The element a₁ is encrypted by using the private key to obtain an encrypted element [a₁]^{m}^{₁} of the first participant P1. The first participant P1 performs the blinding processing on the obtained private key shards by using its own element to obtain the blinded private key shard thereof. In an example, the blinding processing includes subtracting. Then, the blinded private key shard of the first participant P1 may include (x₁−a₁), (y₁−b₁), and (z₁−c₁). Similarly, the blinded private key shard of the first participant P2 may be computed to include (x₂−a₂), (y₂−b₂), and (z₂−c₂). The blinded private key shard of the first participant P3 may include (x₃−a₃), (y₃−b₃), and (z₃−c₃). The encrypted element of the first participant P2 includes [a₂]^{m}^{₂}, the encrypted element of the first participant P3 includes [a₃]^{m}^{₃}, and the first participants P2 and P3 have the private keys m₂ and m₃, respectively.

At Step B4, the private key shard product for the N first participants is computed based on the private key shards, the elements, the element shard product of the first first participant, and the encrypted elements, the private key shards and the blinded private key shards of each second first participant.

Since each first first participant needs to know the blinded private key shard of the second first participant when computing the private key shard product, each second first participant needs to share the blinded private key shard thereof to the first first participant without sharing the elements and the private key information itself, which not only enables each participant to calculate the private key shard product, but also ensures the confidentiality of the element and the private key information of each first participant. In the above example, after each first first participant shares the blinded private key shard thereof to the second first participant, the first participants P1, P2 and P3 obtain the following blinded private key shards: (x₁−a₁), (y₁−b₁), (z₁−c₁), (x₂−a₂), (y₂−b₂), (z₂−c₂), (x₃−a₃), (y₃−b₃), and (z₃−c₃).

In some examples, the element set further includes a blinding factor. The computing of the element shard product for the first first participant (i.e., Step B3) includes: multiplying elements of the first first participant and encrypted elements of the second first participant to obtain a first computation result; performing multiplication between the elements of the first first participant to obtain a second computation result; performing a blinding processing on the first computation result by using the blinding factor to obtain a blinded first computation result; and determining the element shard product of the first first participant based on the blinded first computation result and the second computation result.

The first participant including P1, P2 and P3 is still described as an example. The element set generated by the first participant P1 is denoted by (a₁, b₁, c₁, r₁), the element set generated by the first participant P2 is denoted by (a₂, b₂, c₂, r₂), and the element set generated by the first participant P3 is denoted by (a₃, b₃, c₃, r₃). a₁, b₁, c₁ are elements of the first participant P1, and r₁ is a blinding factor of the first participant P1. a₂, b₂, c₂ are elements of the first participant P2, and r₂ is a blinding factor of the first participant P2. a₃, b₃, c₃ are elements of the first participant P3, and r₃ is a blinding factor of the first participant P3.

The first participant P1 includes the following element shard products: Pₐ_{₁}_{b}_{₁}, Pₐ_{₁}_{c}_{₁}, P_{b}_{₁}_{c}_{₁}, Pₐ_{₁}_{b}_{₁}_{c}_{₁}. Pₐ_{₁}_{b}_{₁} is an element shard product of the elements a₁ and b₁, Pₐ_{₁}_{c}_{₁} is an element shard product of the elements a₁ and c₁, P_{b}_{₁}_{c}_{₁} is an element shard product of the elements b₁ and c₁, and Pₐ_{₁}_{b}_{₁}_{c}_{₁} is an element shard product of the elements a₁, b₁ and c₁. Similarly, the first participant P2 includes the following element shard products: Pₐ_{₂}_{b}_{₂}, Pₐ_{₂}_{c}_{₂}, P_{b}_{₂}_{c}_{₂}, Pₐ_{₂}_{b}_{₂}_{c}_{₂}. The first participant P3 includes the following element shard products: Pₐ_{₃}_{b}_{₃}, Pₐ_{₃}_{c}_{₃}, P_{b}_{₃}_{c}_{₃}, Pₐ_{₃}_{b}_{₃}_{c}_{₃}.

The computation of the element shard product Pₐ_{₁}_{b}_{₁} of the first participant P1 is described as an example. First, multiplication is performed on the element b₁ of the first participant P1 and the encrypted elements [a₂]^{m}^{₂} and [a₃]^{m}^{₃} of the other first participants (i.e., the first participant P2 and the first participant P3) to obtain the first computation result including [a₂]^{m}^{₂}*b₁ and [a₃]^{m}^{₃}*b₁. Multiplication is performed between the elements of the first participant P1 to obtain a second computation result including a₁*b₁. The blinding processing is performed on the first computation result by using the blinding factor r₁ of the first participant P1, to obtain the blinded first computation result including [a₂]^{m}^{₂}*b₁+r₁, [a₃]^{m}^{₃}*b₁+r₁. Then, based on the blinded first computation result and the second computation result, the element shard product of the first participant is determined, and an alternative computation method of the element shard product may be expressed as follows:

$${a}_{1} * {b}_{1} + {[ {a}_{2} ]}^{{m}_{2}} * {b}_{1} + {r}_{1} + {[ {a}_{3} ]}^{{m}_{3}} * {b}_{1} + {r}_{1 - 2} {r}_{1}$$

As can be seen from this formula, the element shard product is obtained by subtracting twice the blinding factor from the sum of the first computation result and the second computation result. The reason for subtracting twice the blinding factor is that the double-blinding factor is introduced when the blinding processing is performed on the first computation result, so that the introduction of the double-blinding factor needs to be eliminated so that the blinding factor does not participate in the subsequent computation process. In the same way of computation, the sum of the element shard products Pₐ_{₁}_{c}_{₁} and P_{b}_{₁}_{c}_{₁} of the first participant P1 may be computed.

In computing the element shard product Pₐ_{₁}_{b}_{₁}_{c}_{₁} of the first participant P1, any one of Pₐ_{₁}_{b}_{₁}, Pₐ_{₁}_{c}_{₁}, and P_{b}_{₁}_{c}_{₁} may be used as the base element, to be computed with the other element. For example, when Pₐ_{₁}_{b}_{₁} is used as the basic element, the element shard product Pₐ_{₁}_{b}_{₁}_{c}_{₁} is computed in the same method as Pₐ_{₁}_{b}_{₁}, which is corresponding to the element shard product of Pₐ_{₁}_{b}_{₁} and c₁.

The computation method of the element shard products of the first participants P2 and P3 is the same as that of the first participant P1, and will not be repeated here.

After the above steps, the seven-tuple of each first participant may be determined, and the seven-tuple includes the element of the first participant and the element shard product. For example, the seven-tuple of the first participant P1 is (a₁, b₁, c₁, Pₐ_{₁}_{b}_{₁}, Pₐ_{₁}_{c}_{₁}, P_{b}_{₁}_{c}_{₁}, Pₐ_{₁}_{b}_{₁}_{c}_{₁}). The seven-tuple of the first participant P2 is a₂, b₂, c₂, Pₐ_{₂}_{b}_{₂}, Pₐ_{₂}_{c}_{₂}, P_{b}_{₂}_{c}_{₂}, Pₐ_{₂}_{b}_{₂}_{c}_{₂}). The seven-tuple of the first participant P3 is a₃, b₃, c₃, Pₐ_{₃}_{b}_{₃}, Pₐ_{₃}_{c}_{₃}, P_{b}_{₃}_{c}_{₃}, Pₐ_{₃}_{b}_{₃}_{c}_{₃}).

Then, the private key shard products of the first participants P1, P2, P3 are computed by using the seven tuples corresponding to the first participants P1, P2, P3, respectively.

When computing the private key shard products of the first participants P1, P2, P3, each of the first participants calculates the private key shard product of the first participant locally. The computation of the private key shard product of the first participant P1 by the first participant P1 is still described as an example. The private key information of the first participant P1 is X, the private key information of the first participant P2 is Y, and the private key information of the first participant P3 is Z. In some examples, the computation of the private key shard product of the first participant P1 may be represented by the following formula:

$$X * Y * Z = ( X - a ) ( Y - b ) ( Z - c ) + {a}_{1} ( Y - b ) ( Z - c ) + {b}_{1} ( Z - c ) ( X - a ) + {c}_{1} ( X - a ) ( Y - b ) + {P}_{{a}_{1} {b}_{1}} ( Z - c ) + {P}_{{b}_{1} {c}_{1}} ( X - a ) + {P}_{{a}_{1} {c}_{1}} ( Y - b ) + {P}_{{a}_{1} {b}_{1} {c}_{1}}$$

In this formula, X*Y*Z represents the private key shard product of the private key shards for the first participants P1, P2, and P3 and a₁, b₁, c₁ represents elements of the first participant P1.

As described in the above embodiment, after each first participant shares the blinded private key shards thereof to other first participants, the first participants P1, P2, P3 obtain the following blinded private key shards: (x₁−a₁), (y₁−b₁), (z₁−c₁), (x₂−a₂), (y₂−b₂), (z₂−c₂), (x₃−a₃), (y₃−b₃), and (z₃−c₃), respectively. In combination with x₁+x₂+x₃=X, a₁+a₂+a₃=a, b₁+b₂+b₃=b, and c₁+c₂+c₃=c, the first participant P1 sums the blinded private key shards (x₁−a₁), (x₂−a₂), and (x₃−a₃) to obtain a value of (X−a), sums the blinded private key shards (y₁−b₁), (y₂−b₂), and (y₃−b₃) to obtain a value of (Y−b), and sums the blinded private key shards (z₁−c₁), (z₂−c₂), and (z₃−c₃) to obtain a value of (Z−c).

After the above computation, each of the first participants P1, P2, P3 calculates a private key shard product X*Y*Z for the first participant. The value of the private key shard product computed by each of the first participants P1, P2, and P3 is same as that of other one of the first participants P1, P2, P3.

From the above-described embodiment, it can be determined that each of the plurality of first first participants does not disclose the private key information thereof when computing the private key shard product, but shares the share (i.e., the private key shard) of the private key information thereof to the second first participant (i.e., the other first participants), and performs the blinding processing before exchanging data with the second first participant, thereby protecting the security of the private key information thereof in multiple ways.

In an embodiment, the encrypting of the plaintext data of each of the M participants by using the key information to obtain the ciphertext data of each of the M participants including: obtaining a key parameter of the key information for each participant, where the key parameter includes a plurality of random numbers; encrypting the plaintext data based on the random numbers and the key information by using a plurality of different encryption methods to obtain a plurality pieces of first encrypted data; performing exclusive OR processing on the plurality pieces of first encrypted data to obtain the second encrypted data; and performing desensitization processing on the second encrypted data to obtain the ciphertext data of the participant.

In some examples, the key parameters further include the primitive root and the key modulus. For example, the key parameters include the primitive root g, a key modulus p, and a plurality of random numbers including a first random number R and a second random number S. An encryption method for encrypting the plaintext data includes the following steps:
performing first encryption by using the following formula to obtain the first encrypted data:

$${c}_{1} = {g}^{s} mod p ,$$

where c₁ represents the first encrypted data;
performing second encryption by using the following formula to obtain another first encrypted data:

$${c}_{2} = ( {R}^{m} * {pk}^{s} ) mod p ,$$

where c₂ represents the other first encrypted data. m represents the plaintext data, and k is the key information computed in step S104; and
performing the exclusive OR processing on c₁ and c₂ to obtain the second encrypted data. In some examples, any desensitization method in the related art may be used to desensitize the second encrypted data. For example, the SHA-256 algorithm is used to desensitize the second encrypted information.

In an embodiment, at Step S104, under the condition that the number of participants (that is, the value of M) is greater than a preset threshold, a shard operation may be performed on the private key information of the M participants according to the shard operation protocol to obtain the key information.

Under the condition that the number of participants (that is, the value of M) is less than or equal to the preset threshold, the plaintext data of each participant is encrypted independently and sequentially with the private key information of respective ones of the M participants to obtain the ciphertext data for each participant. That is, respective ones of the participants encrypt the same plaintext data in sequence respectively by using their private key information, and the sequence for encryption is not limited. The encrypted ciphertext data is unchanged even by using the different sequences for encryption, and no single party may independently decrypt the ciphertext data.

The size of the preset threshold is not limited in the embodiments of the present disclosure, and may be determined according to an actual computing environment and a participant's requirement.

In an example, the preset threshold is five, and three participants are used as an example to compute the ciphertext data. The private key information of the participant P1 is k₁, the private key information of the participant P2 is k₂, and the private key information of the participant P3 is k₃. Since the number of participants is less than the preset threshold, there is no need for a third participant (i.e., another party different from the three participants P1, P2, and P3) to participate in the computation process. A private key modulus included in the private key information of each participant is locally generated by the participant, and the private key modulus is used to constrain the range of the private key information, for example, if the private key modulus is 1024, the generated private key information should not exceed 1024. After the three participants generate the private key moduli, respectively, each of the three participants discloses, that is, shares, its own private key modulus to other ones of the three participants. Each participant, after receiving the private key moduli of all participants, selects one of the private key moduli as the private key modulus to be used in the current computation. To ensure that the final private key moduli selected by respective ones of the participants are same as each other, a selection rule may be set in advance. For example, one of all the private key moduli having a maximum value is selected as the private key modulus to be used in the current computation. Each participant then generates the private key information thereof locally based on the private key modulus.

In an encryption operation according to an embodiment, each participant (e.g. P1) encrypts its own plaintext data by using its own private key information to obtain a local encrypted ciphertext of the participant (e.g. P1). The local encrypted ciphertext is expressed by the following formula:

$$E ( {u}_{ij} ) = {( {u}_{ij} )}^{{k}_{i}} mod P ( i = 0 , 1 , 2 ; j = 0 , 1 , 2 ¨ n ) ,$$

where i represents a participant (e.g. P1) for currently performing the encryption operation for obtaining the local encrypted ciphertext, that is, the i-th participant, j represents the plaintext data being currently encrypted, that is, the j-th plaintext data is encrypted, and n represents the amount of data of the plaintext data. kᵢ represents the private key information of the i-th participant (e.g. P1), and P is the final private key modulus selected by respective ones of the participants.

Each of the participants (e.g. P1) then transmits the computed local encrypted ciphertext thereof to the next one of the participants in sequence, and the next one of the participants further encrypts the same plaintext data (i.e., the computed local encrypted ciphertext) by using its own private key information, until all participants have encrypted the same plaintext data. In the case where the next one (e.g. P2) of the participants receives the ciphertext data transmitted from each of the participants (e.g. P1), the secondary encryption operation may be expressed as follows:

$$E ( {u}^{′} ) = {( {u}^{″} )}^{{k}_{j}} mod p ( j = 0 , 1 , 2 ¨ n ) .$$

The participant (e.g. P2) performs the secondary encryption operation returns the ciphertext data to the sender (e.g. P1), and the sender sends the returned ciphertext data to another next participant for encryption until all the participants have encrypted the same plaintext data. The final ciphertext data obtained by respective ones of the participants may be expressed as the following formula:

$$E ( {u}^{″} ) = {( {u}_{ij} )}^{{k}_{1} {k}_{2} {k}_{3}} mod P ( i = 0 , 1 , 2 ; j = 0 , 1 , 2 ¨ n ) ,$$

where k1, k2, and k3 are the private key information of the participants P1, P2, and P3, respectively.

In an embodiment, the data processing method further includes: before Step S102, pre-encoding raw data of each participant. The reason is that: the raw data to be used for performing data computation process includes a character string or a non-numeric value type data, but the encryption process (such as Step S106) is a mathematical operation and cannot directly encrypt the character string and the non-numeric value type data, encoding processing is required to be included in the data computation process.

The pre-encoding of the raw data of the each participant may include: performing bit-wise encoding on the raw data, where an exemplary encoding method utilizes the ASCII encoding standard; converting each ASCII character to its binary representation to obtain a binary encoding corresponding to each ASCII character, and then respective ones of the binary encodings are spliced to obtain a converted binary encoding of a numeric value type; and converting the converted binary encoding of the numeric value type into a decimal numeric representation to obtain a converted decimal encoding of the numeric value type. The converted decimal encoding of the numeric value type may be used as the plaintext data in the Step S102 to Step S108.

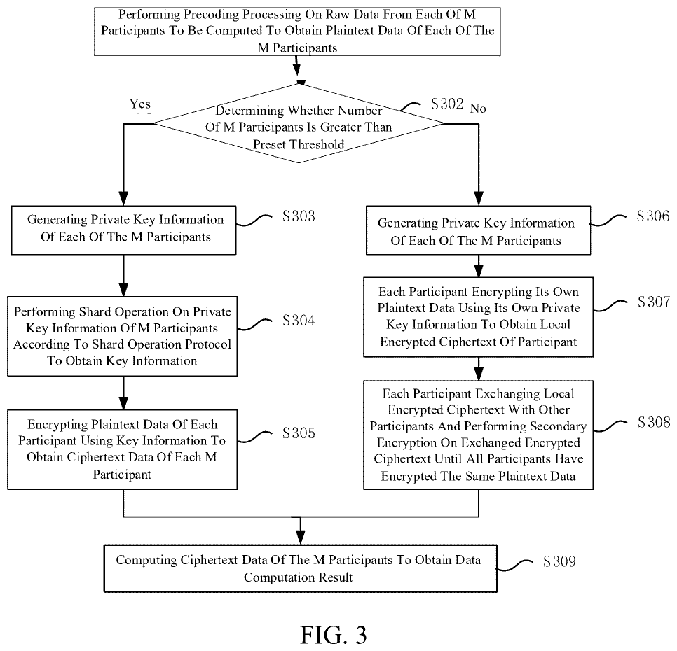

FIG. 3 is a schematic flowchart of another example of a data processing method according to some embodiments of the present disclosure. As shown in FIG. 3, the data processing method includes Step S301 to Step S309.

At Step S301, precoding processing is performed on raw data from each of M participants to be computed to obtain plaintext data of each of the M participants, where M is an integer greater than 1.

At Step S302, it is determined whether the number of the M participants is greater than a preset threshold; If yes, executing Step S303, and if no, executing Step S306.

At Step S303, private key information of each of the M participants is generated.

At Step S304, a shard operation is performed on the private key information of the M participants according to a predetermined shard operation protocol to obtain key information for the M participants.

Where the shard operation protocol may be a secure multiplication operation protocol. The performing of the shard operation on the private key information of the M participants has been described in detail in the above embodiments, and will not be repeated here.

At Step S305, the plaintext data of each of the M participants is encrypted by using the key information to obtain ciphertext data of each of the M participants. After Step S305, the process proceeds to Step S309.

At Step S306, private key information of each of M participants is generated.

At Step S307, each participant encrypts its own plaintext data by using its own private key information to obtain a local encrypted ciphertext of the participant.

At Step S308, each of the participants exchanges the local encrypted ciphertext thereof with other of the participants and other of the participants, and performs secondary encryption on the exchanged encrypted ciphertext until all participants have encrypted the same plaintext data to obtain a multi-encrypted plaintext data as the ciphertext data of each participant.

At Step S309, ciphertext data of the M participants is computed to obtain a data computation result for the M participants.

It can be seen that in an embodiment of the present disclosure, when the number of participants is greater than the preset threshold, the key information is obtained by performing the shard operation on the private key information of the M participants, the generation of the key information requires the participation of the M participants (that is, all participants), which not only increases the complexity of the key information itself, but also makes decryption of the ciphertext data also require the common participation of the participants, thereby increasing the difficulty of cracking the ciphertext data. Even if the data computation result has been known, it is difficult for one of the participants to infer the plaintext data of other participants from the data computation result without key information for decryption, thereby ensuring the security of the plaintext data of each participant. When the number of participants is less than or equal to the preset threshold, the plaintext data of each participant is sequentially encrypted by respective ones of the participants, so that the ciphertext data obtains multiple encryption measures, thereby ensuring the security of the plaintext data of each participant. In addition, the method for computing the key information may be changed with the number of participants, and therefore may be applied to the set operation for any number of participants.

In an embodiment, when the number of participants is greater than the preset threshold, a third party may be participated in the computation of the key information to ensure fairness and privacy of the key information of the key information. The third party must be a trusted party, e.g., a trusted authority, a trusted platform, etc.

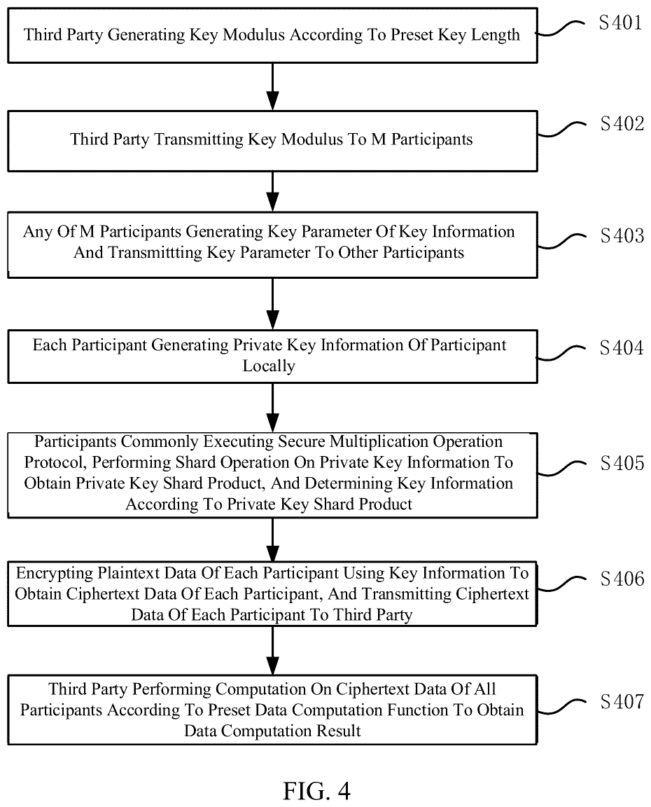

FIG. 4 is a schematic flowchart of yet another example of a data processing method according to some embodiments of the present disclosure. In this example, the third party and the M participants collaborate to complete the data computation process. As shown in FIG. 4, the data processing method includes Step S401 to Step S407.

At Step S401, the third party generates a key modulus according to a preset key length.

At Step S402, the third party transmits the key modulus to the M participants.

At Step S403, any of the M participants generates a key parameter of the key information, and transmits the key parameter to other ones of the M participants.

The key parameter include a primitive root, an encrypted random number, a random large prime number, and the like. Illustratively, the key parameter is generated by the participant P1. In the practical application, the third party may randomly select any participant to perform Step S403.

At Step S404, each of the M participants generates private key information of the participant locally.

At Step S405, the M participants commonly execute a secure multiplication operation protocol, perform a shard operation on the private key information of the M participants respectively to obtain the private key shard product for M participants, and determines the key information according to the private key shard product.

In the computation process, each participant shares a portion of the private key shards thereof with others of the participants, but does not share the complete private key information, thereby ensuring the confidentiality of the private key information of each participant. The computation process of the private key shard product and the process of determining the key information based on the private key shard product have been described in detail in the above-mentioned embodiments and will not be repeated here.

At Step S406, the plaintext data of each of the M participants is encrypted by using the key information to obtain ciphertext data of each of the M participants, and the ciphertext data of each of the M participants is transmitted to the third party.

At Step S407, the third party performs computation on the ciphertext data of all participants according to a preset data computation function to obtain a data computation result of the M participants.

Here, the data computation function may be determined according to the actual scene or the requirement for the computation type of the multi-party data. For example, when it is necessary to perform a union operation on the multi-party data, the data computation function is a union operation function. When it is necessary to perform a set intersection operation on the multi-party data, the data computation function is an intersection operation function.

After Step S407, the third party may send the data computation result to each of the participants; or the third party may not send the data computation result to each of the participants, but may send the data computation result to a organization or platform that needs to use the data computation result.

It can be seen that, in the present embodiment, the data computation is performed by the third party and M participants in cooperation, and the obtaining of the key information is performed by dividing the complete private key information into smaller granularities (i.e., shards) for interaction between the M participants. Therefore, each of the third party and the participants may only obtain the final computed data computation result, but cannot obtain the plaintext data and the private key information of other participants, thereby ensuring the security of the plaintext data of each participant.

In an embodiment, after ciphertext data of the M participants is computed to obtain a data computation result for the M participants, any one of the M participants is determined to be an anonymous participant, and the anonymous participant performs anonymization processing on the data computation result to obtain an anonymous data computation result.

The anonymous participant may be randomly selected by the third party, and the anonymous participant performs anonymization processing on the data computation result by using an oblivious pseudorandom protocol/function. Since the participant does not know which participant is selected by the third party as the anonymous participant, the anonymized data computation result is equivalent to completely anonymized, and any one or part of the participants cannot collaborate with the third party to decrypt the data, thereby further ensuring the security of the data.

The following lists several example scenarios in which the data processing method according to the embodiments of the present disclosure may be applied.

Scenario 1: In the field of combating financial black industries, the black-and-grey organization exploits the problem of data isolation in the financial industry, and attaches different peer organizations by using the same modus operandi, such as launching malicious attacks such as malicious complaints and malicious representation of rights, so as to reduce interest and compensate. At present, more and more attention has been paid to the issue of data security, and there is no good means for data fusion among the peer organizations to provide a blacklist database for the prevention of such illegal activities. The biggest issue is the data security. Any peer organization (or participant) is unwilling to share the accumulated list of fraudulent and illicit actors directly, which leads to the inability to cope with such illegal activities. By using the data processing method according to embodiments of the present disclosure, an union operation (that is, data fusion, such as the secure set union computation) may be performed on the premise of ensuring the confidentiality of the data of each organization to obtain the data fusion result of each organization, thereby ensuring that the blacklist data of each organization may be safely fused. Moreover, the data processing method according to the embodiments of the present disclosure is not limited to the number of organizations, and even if the number of organizations involved in the computation is greater (for example, ten or more), the performance of the union operation is not greatly affected.

In this scenario, the consortium operator acts as a neutral third party to coordinate the set union computation with participating organizations. The detailed scheme is described below.

First, each organization uploads its own blacklist data to local environment locally (i.e., on the local node).

Next, the consortium operator initiates a union operation task, and each organization runs a multi-party secure multiplication operation protocol (or the above secure multiplication operation protocol) based on the union operation task, and perform computation to obtain key information for encrypting the blacklist data. Each organization encrypts its own blacklist data by using the key information to obtain encrypted ciphertext data, and sends the encrypted ciphertext data to the consortium operator. The consortium operator performs the union operation on a plurality of pieces of ciphertext data to obtain a union operation result for the blacklist data of each organization, that is, a data fusion result or the data computation result.

Next, the consortium operator pushes the union operation result for the blacklist data to the cache middleware (such as Redis and MySQL) of the real-time query service so that each organization may query the union operation result.

In this scenario, by using the multi-party security multiplication operation protocol and the privacy union operation mode, the computation of the set union of data of the plurality of organizations about black-and-grey industries is realized, and the pieces of blacklist data of respective ones of the organizations are all sent to the consortium operator, thereby effectively blocking the malicious attack behavior of the same black-and-grey organization. In addition, the consortium operator cannot learn the key information, and decryption operation requires the participation of respective ones of the participants (i.e., all organizations). Therefore, the security of the blacklist data is ensured from the technical level, and the blacklist data is not leaked. Moreover, since the set union computation only involves the generation of the key information which requires the participation of all the participants, the overall computing performance may be ensured, and the computing performance is not greatly degraded with the increase of the participants.

Scene 2: At present, most of the organizations need to rely on external data sources. For interrelated or cross-industry organizations, the insufficient samples or features of their own data will lead to the modeling effect in some scenarios does not meet expectations, or the model fitting effect is not good. Meanwhile, the modeled samples or feature data need to be expanded by performing the union operation on the data of the plurality of organizations. In the related art, most organizations directly desensitize data by using SHA-256, put plaintext data (for example, user ID) and feature data together in a trusted environment, perform joint modeling, then go online the trained model, combine the data features of both parties in real-time services, and apply the results to their own business scenarios, such as financial and medical industries. However, these encryption method is relatively simple, and data security cannot be truly ensured. In the data processing method according to the embodiments of the present disclosure, the user ID may perform a union operation in a security situation, so that the sensitive data such as the user ID may be anonymized, and the data security of the user ID may be protected.

Each agency first prepares data to be modeled locally, such as a user ID, and locally generates an anonymous ID for each user ID. Then, each organization performs a union operation using the data processing method according to an embodiment of the present disclosure to obtain a union operation result, returns the union operation result and the anonymous ID to the corresponding organization, and the organization locally extracts user information corresponding to the anonymous ID, such as label information and feature data, and sends the extracted user information to the modeler. The modeler collects the user information sent by the organization, completes the model training, and sends the trained model to all the organizations for use.

During the execution process, when each organization locally prepares the data to be modeled, each organization generates a random anonymous ID for each piece of data, for example, a corresponding anonymous ID for each user ID, to obtain the data structure forms as follows: [uid, anonymous id, label, feature0 . . . ]. Here, the anonymous ID is generated locally and randomly, and may be, for example, a unique identification code such as Universally Unique Identifier (UUID). The mapping relationship between the user ID and the anonymous ID is known only to the each organization itself, and other organizations cannot obtain the generation of the anonymous ID by any technical means. label is label information for modeling, typically zero (0) and one (1), and uid represents the unique identity of each user, such as a cell phone number, an identity card number, a device unique identity, etc.

Then, each organization performs a union operation by using the data processing method according to an embodiment of the present disclosure, and the modeler (i.e., a third party) obtains the union operation result and the pieces of identification information of respective ones of the organizations from the organizations. The pieces of identification information is U=[<encrypted ID, [(anonymous ID1, organization 1), (anonymousID2, organization 2)]>, . . . ]. Here, the encrypted ID represents the union operation result. The modeler returns the anonymous ID of each organization to the each organization.

Then, each organization associates the local data with the received anonymous ID based on the received anonymous ID to obtain a set D of anonymous ID, feature data, and label information as follows: D=[(anonymous ID, label information, feature 1, feature . . . ))] and returns the set D to the modeler.

Finally, the modeler associates the locally computed union operation result with the received the set D to perform subsequent joint modeling.

In sum, some specific embodiments of the present disclosure have been described. Other embodiments are within the scope of the appended claims. In some cases, the operations recited in the claims may be performed in a different order and the desired results may still be achieved. In addition, the processes depicted in the drawings do not necessarily require the particular order or sequential order shown to achieve the desired results. In certain embodiments, multitasking and parallel processing may be performed.

The data processing method according to the foregoing embodiments of the present disclosure are provided, based on the same conception, the embodiment of the present disclosure further provides a data processing apparatus.

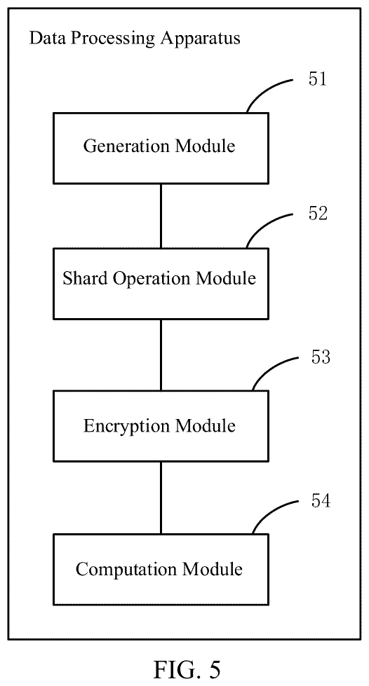

FIG. 5 is a schematic block diagram of a data processing apparatus according to an embodiment of the present disclosure. As shown in FIG. 5, the data processing apparatus includes:
a generation module 51, configured to generate private key information of each of M participants to be computed according to the participant, wherein M is greater than 1;
a shard operation module 52, configured to perform a shard operation on the private key information of the M participants according to a predetermined shard operation protocol to obtain key information for the M participants;
an encryption module 53, configured to encrypt plaintext data of each of the M participants by using the key information to obtain ciphertext data of the participant; and
a computation module 54, configured to perform computation on the ciphertext data of the M participants to obtain a data computation result for the M participants.

In an embodiment, the shard operation protocol comprises a secure multiplication operation protocol;

The shard operation module 52 perform a shard operation on the private key information of the M participants according to a predetermined shard operation protocol to obtain key information by performing the following steps:
performing a secure multiplication operation on the private key information of the M participants according to the secure multiplication operation protocol to obtain a private key shard product for the M participants; and
determining the key information based on the private key shard product for the M participants.

In an embodiment, the slicing operation module 52 performs the following steps when performing the secure multiplication operation on the private key information of the M participants according to the secure multiplication operation protocol to obtain a private key shard product:
constructing a computation queue of the M participants;
iteratively performing, for the computation queue, the following steps until the private key shard product of a last one of the participants in the computation queue is determined:
extracting first N participants from the computation queue as first participants to be computed, and computing a private key shard product for the N first participants based on the private key information of the N first participants; wherein N is an integer greater than 1 and less than M;
adding one first participant selected from the N first participants to a head of a remaining portion of the computation queue excluding the N first participants to obtain an updated computation queue; and updating the private key information of the one first participant located at a head of the updated computation queue with the private key shard product for the N first participants; and
computing a private key shard product for first N participants of the updated computation queue.

In an embodiment, the shard operation module 52 performs the steps of:
generating an element set of each of the N first participants, wherein the element set comprises at least one element;
sharding the private key information of each of the N first participants to obtain private key shards of the first participant;
for each of the N first participants, obtaining an encrypted element, a private key shard, and a blinded private key shard from other ones of the N first participants, where the encrypted element of each of the other ones of the N first participants is obtained by encrypting the element in the element set thereof by using a private key thereof, the blinded private key shard of each of the other ones of the N first participants is obtained by binding the private key shard thereof by using the element thereof, and the N first participants includes the each of the N first participants as a first first participant and the other ones of the N first participants as a second first participants; and

computing the private key shard products for the N first participants based on the private key shard, the element, and the element shard product of the first participants, and the encrypted elements, the private key shard, and the blinded private key shards of the second first participants.

In an embodiment, the element set further comprises a blinding factor;

The shard operation module 52 performs the following steps when computing the element shard product of the first participant:
multiplying an element of the first first participant and the encrypted element of each of the second first participants to obtain a first computation result;
performing multiplication between two of the at least one element of the first first participant to obtain a second computation result;
performing a blinding process on the first computation result by using the blinding factor to obtain a blinded first computation result; and
determining the element shard product of the first first participant based on the blinded first computation result and the second computation result.

In an embodiment, the shard operation module 52 performs the step of determining the private key shard product of a last one of the participants in the computation queue as the key information.

In an embodiment, the encryption module 53 performs the following steps when encrypting the plaintext data of each of the M participants by using the key information to obtain ciphertext data of each of the M participants:
obtaining a key parameter of the key information for each of the M participants, wherein the key parameter includes a plurality of random numbers;
encrypting the plaintext data of each of the M participants based on the random numbers and the key information by using a plurality of different encryption methods to obtain a plurality pieces of first encrypted data;
performing exclusive OR processing on the plurality pieces of first encrypted data to obtain the second encrypted data; and
performing desensitization processing on the second encrypted data to obtain the ciphertext data of each of the M participants.

In an embodiment, the shard operation module 52 performs the following steps when performing the shard operation on the private key information of the M participants according to the predetermined shard operation protocol to obtain the key information:
under the condition that a value of M is greater than a preset threshold, performing the shard operation on the private key information of the M participants according to the shard operation protocol to obtain the key information.

In an embodiment, the encryption module 53 performs the following steps when encrypting the plaintext data of each of the M participants by using the key information to obtain the ciphertext data of each of the M participants:
under the condition that a value of M is less than or equal to the preset threshold, encrypting the plaintext data of each of the M participants independently and sequentially with the private key information of respective ones of the M participants to obtain the ciphertext data for each of the M participants.

In an embodiment, the data processing apparatus further comprises:
a determining module, configured to: after computing the ciphertext data of the M participants to obtain the data computation result for the M participants, determine any one of the M participants is determined to be an anonymous participant; and
an anonymization processing module, configured to perform anonymization processing on the data computation result by the anonymous participant to obtain an anonymous data computation result.

In the data processing apparatus according to some embodiments of the present disclosure, the private key information of each participant is generated, the shard operation is performed on the private key information of M participants (M is the number of participants) according to a preset shard operation protocol to obtain key information, the plaintext data of each of the M participants is encrypted by using the key information to obtain ciphertext data of each of the M participants, and the pieces of ciphertext data of the M participants are computed to obtain a data computation result for the M participants. Since the key information is obtained by performing the shard operation on the private key information of the M participants, the generation of the key information requires the participation of the M participants (that is, all participants), which not only increases the complexity of the key information itself, but also makes decryption of the ciphertext data also require the common participation of the participants, thereby increasing the difficulty of cracking the ciphertext data. Even if the data computation result has been known, it is difficult for one of the participants to infer the plaintext data of other participants from the data computation result without key information, thereby ensuring the security of the plaintext data of each participant.

It will be appreciated by those skilled in the art that the data processing apparatus of FIG. 5 can be used to implement the data processing method described above, the detailed description of which should be similar to that in the previous method section, and for the avoidance of complexity, details will not be described herein.

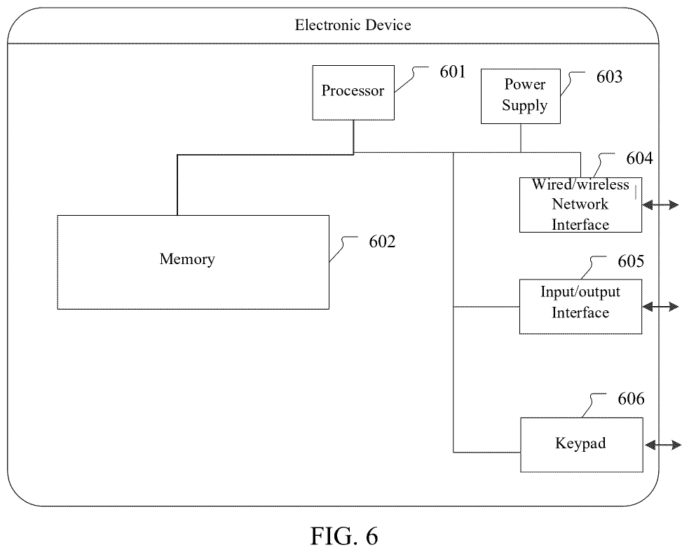

Based on the same concept, an embodiment of the present disclosure also provides an electronic device, as shown in FIG. 6. The electronic devices may differ considerably by configuration or performance thereof and may include one or more processors 601 and a memory 602 in which one or more stored applications or data may be stored. The memory 602 may be a temporary storage or a persistent storage. The application program stored in memory 602 may include one or more modules (not shown), each of the modules may include a series of computer-executable instructions for an electronic device. Still further, the processor 601 may be configured to communicate with memory 602 to execute a series of computer-executable instructions in memory 602 on an electronic device. The electronic device may further include one or more power supplies 603, one or more wired or wireless network interfaces 604, one or more input/output interfaces 605, one or more keypads 606.

In an embodiment, the electronic device includes a memory, and one or more programs, wherein the one or more programs are stored in the memory, and the one or more programs may include one or more modules, and each module may include a series of computer-executable instructions for the electronic device, and configured to execute the one or more programs by the one or more processors includes computer-executable instructions for:
generating private key information of each of M participants to be computed according to the participant, where M is greater than 1;
performing a shard operation on the private key information of the M participants according to a predetermined shard operation protocol to obtain key information for the M participants;
encrypting plaintext data of each of the M participants by using the key information to obtain ciphertext data of the participant; and
performing computation on the ciphertext data of the M participants to obtain a data computation result for the M participants.

According to the technical solution of the embodiment of the present disclosure, the private key information of each participant is generated, the shard operation is performed on the private key information of M participants (M is the number of participants) according to a preset shard operation protocol to obtain key information, the plaintext data of each of the M participants is encrypted by using the key information to obtain ciphertext data of each of the M participants, and the pieces of ciphertext data of the M participants are computed to obtain a data computation result for the M participants. Since the key information is obtained by performing the shard operation on the private key information of the M participants, the generation of the key information requires the participation of the M participants (that is, all participants), which not only increases the complexity of the key information itself, but also makes decryption of the ciphertext data also require the common participation of the participants, thereby increasing the difficulty of cracking the ciphertext data. Even if the data computation result has been known, it is difficult for one of the participants to infer the plaintext data of other participants from the data computation result without key information, thereby ensuring the security of the plaintext data of each participant.

An embodiment of the present disclosure further provides a computer-readable storage medium storing one or more computer programs including instructions that, when executed by an electronic device including a plurality of application programs, enable the electronic device to perform various operations of the above-described data processing method, and specifically for performing:
generating private key information of each of M participants to be computed according to the participant, where M is greater than 1;
performing a shard operation on the private key information of the M participants according to a predetermined shard operation protocol to obtain key information for the M participants;
encrypting plaintext data of each of the M participants by using the key information to obtain ciphertext data of the participant; and
performing computation on the ciphertext data of the M participants to obtain a data computation result for the M participants.

According to the technical solution of the embodiment of the present disclosure, the private key information of each participant is generated, the shard operation is performed on the private key information of M participants (M is the number of participants) according to a preset shard operation protocol to obtain key information, the plaintext data of each of the M participants is encrypted by using the key information to obtain ciphertext data of each of the M participants, and the pieces of ciphertext data of the M participants are computed to obtain a data computation result for the M participants. Since the key information is obtained by performing the shard operation on the private key information of the M participants, the generation of the key information requires the participation of the M participants (that is, all participants), which not only increases the complexity of the key information itself, but also makes decryption of the ciphertext data also require the common participation of the participants, thereby increasing the difficulty of cracking the ciphertext data. Even if the data computation result has been known, it is difficult for one of the participants to infer the plaintext data of other participants from the data computation result without key information, thereby ensuring the security of the plaintext data of each participant.

An embodiment of the present disclosure provides a computer program product including a computer program, which is executed by a processor to implement the operations of the above-described data processing method, and achieves the same technical effect as the above-described data processing method. To avoid repetition, details are not described herein.

The system, apparatus, module or unit set forth in the above embodiments may be embodied by a computer chip or entity or by a product having a certain function. A example implementation device is a computer. The computer may be, for example, a personal computer, a laptop computer, a cellular phone, a camera phone, a smart phone, a personal digital assistant, a media player, a navigation device, an email device, a game console, a tablet computer, a wearable device, or a combination of any of these devices.

For convenience of description, the above apparatus is described separately in terms of various units of the above apparatus divided according to functions of the above apparatus. Of course, the functions of the units may be implemented in the same software and/or hardware when implementing the present disclosure.

Those skilled in the art will appreciate that embodiments of the present disclosure may be provided as a method, system, or computer program product. Thus, the present disclosure may take the form of a full hardware embodiment, a full software embodiment, or an embodiment incorporating both software and hardware aspects. Furthermore, the present disclosure may take the form of a computer program product embodied on one or more computer usable storage media (including, but not limited to, magnetic disk memory, CD-ROM, optical memory, etc.) having computer usable program code embodied therein.

The present disclosure is described with reference to flowcharts and/or block diagrams of methods, devices (systems), and computer program products according to embodiments of the present disclosure. It is to be understood that each flow and/or block in the flow diagrams and/or block diagrams, and combinations of flow and/or block in the flow diagrams and/or block diagrams may be implemented by computer program instructions. These computer program instructions may be provided to a processor of a general purpose computer, special purpose computer, embedded processor, or other programmable data processing device to produce a machine such that the instructions executed by the processor of the computer or other programmable data processing device produce means for implementing the functions specified in the flowchart flow or flows and/or block diagram block or blocks.

These computer program instructions may also be stored in a computer-readable memory capable of directing a computer or other programmable data processing apparatus to operate in a particular manner, such that the instructions stored in the computer-readable memory produce an article of manufacture including instruction means that perform the functions specified in the flowchart flow or flows and/or block diagram block or blocks.

These computer program instructions may also be loaded onto a computer or other programmable data processing device such that a series of operational steps are performed on the computer or other programmable device to produce a computer-implemented process, such that the instructions that execute on the computer or other programmable device provide steps for implementing the functions specified in the flowchart flow or flows and/or block diagram block or blocks.

In an example configuration, a computing device includes one or more processors (CPUs), input/output interfaces, network interfaces, and memory.

The memory may include non-permanent memory in the computer-readable medium, random access memory (RAM), and/or non-volatile memory, such as read only memory (ROM) or flash memory (flash RAM). The memory is an example of a computer-readable medium.

Computer-readable media, including permanent and non-permanent, removable and non-removable media, may be implemented for information storage by any method or technique. The information may be computer readable instructions, data structures, modules of a program, or other data. Examples of storage media for a computer include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only optical disk (CD-ROM), digital versatile disks (DVD) or other optical storage, magnetic cassette tape, magnetic tape magnetic disk storage or other magnetic storage device, or any other non-transmission medium that can be used to store information that can be accessed by a computing device. As defined herein, a computer-readable medium does not include a transitory medium, such as a modulated data signal and a carrier wave.

It is also noted that the terms “comprise/comprising” “include/including” or any other variation thereof, are intended to cover a non-exclusive inclusion, such that a process, method, article, or apparatus that comprises a list of elements includes not only those elements but also other elements not expressly listed, or also includes elements inherent to such process, method, article, or apparatus. Without more limitations, elements defined by the statement “include a . . . ”, do not exclude the present of additional identical elements in the process, method, article of merchandise or apparatus including the above elements.

The present disclosure may be described in the general context of computer-executable instructions executed by a computer, such as program modules. Generally, program modules include routines, programs, objects, components, data structures, etc. that perform particular tasks or implement particular abstract data types. The present disclosure may also be practiced in distributed computing environments in which tasks are performed by remote processing devices connected through a communication network. In a distributed computing environment, program modules may be located in local and remote computer storage media, including storage devices.

The various embodiments in the present disclosure are described in a progressive manner. Reference may be made to each other for the same and similar parts among the various embodiments. Each embodiment focuses on differences from other embodiments. In particular, with respect to the system embodiment, since it is substantially similar to the method embodiment, the description of the system embodiment is relatively simple, and reference may be made to the partial description of the method embodiment.

Some embodiments of the present disclosure have been described in detail above. The description of the above embodiments merely aims to help to understand the present disclosure. Many modifications or equivalent substitutions with respect to the embodiments may occur to those of ordinary skill in the art based on the present disclosure. Thus, these modifications or equivalent substitutions shall fall within the scope of the present disclosure.

What is claimed is:

1. A data processing method, comprising:
generating respective private key information of M participants, where M is an integer greater than 1;
performing a shard operation on the respective private key information of the M participants according to a predetermined shard operation protocol, to obtain key information;
encrypting plaintext data of each of the M participants using the key information, to obtain respective ciphertext data of the M participants; and
performing computation on the respective ciphertext data of the M participants to obtain a data computation result for the M participants.

2. The data processing method of claim 1, wherein the predetermined shard operation protocol comprises a secure multiplication operation protocol; and
the performing of the shard operation on the respective private key information of the M participants according to the predetermined shard operation protocol to obtain the key information comprises:
performing a secure multiplication operation on the respective private key information of the M participants according to the secure multiplication operation protocol, to obtain respective private key shard products for the M participants; and
determining the key information based on the respective private key shard products for the M participants.

3. The data processing method of claim 2, wherein the performing of the secure multiplication operation on the respective private key information of the M participants to obtain the respective private key shard products for the M participants comprises:
constructing a computation queue of the M participants; and
iteratively performing the following sub-operations on the computation queue until one of the respective private key shard products for last one of the M participants in the computation queue is determined:
extracting first N participants from the computation queue as N first participants, where N is an integer greater than 1 and less than M;
computing a private key shard product for each of the N first participants based on respective private key information of the N first participants; and
selecting one of the N first participants, updating the private key information of the selected one of the N first participants with the private key shard product for each of the N first participants, and adding the selected one of the N first participants to a head of a remaining portion of the computation queue except the N first participants, to update the computation queue.

4. The data processing method of claim 3, wherein the computing of the private key shard product for each of the N first participants based on the respective private key information of the N first participants comprises:
for each of the N first participants, generating an element set comprising at least one element, computing an element shard product, and sharding the private key information of the each of the N first participants to obtain private key shards; and
for each of the N first participants,
obtaining at least one encrypted element, private key shards and blinded private key shards of each one of the N first participants other than the each of the N first participants, wherein the at least one encrypted element is obtained by encrypting the at least one element of the each one of the N first participants using a private key of the each one of the N first participants, and the blinded private key shards are obtained by binding the private key shards of the each one of the N first participants using the at least one element of the each one of the N first participants; and
computing the private key shard product for the each of the N first participants based on the private key shards, the at least one element and the element shard product of the each of the N first participants, and the at least one encrypted element, the private key shards and the blinded private key shards of the each one of the N first participants.

5. The data processing method of claim 4, wherein the element set comprises at least two elements and a blinding factor; and
the computing of the element shard product of the each of the N first participants comprises:
performing a multiplication operation on the at least two elements of the each of the N first participants and the at least one encrypted element of the each one of the N first participants to obtain a first computation result;
performing a multiplication operation on the at least two elements of the each of the N first participants to obtain a second computation result;
blinding the first computation result using the blinding factor; and
determining the element shard product of the each of the N first participants based on the blinded first computation result and the second computation result.

6. The data processing method of claim 3, wherein the determining of the key information based on the respective private key shard products for the M participants comprises:
taking the one of the respective private key shard products for the last one of the M participants in the computation queue as the key information.

7. The data processing method of claim 1, wherein the encrypting of the plaintext data of each of the M participants by using the key information to obtain the respective ciphertext data of the M participants comprises:
obtaining a key parameter of the key information, wherein the key parameter comprises a plurality of random numbers; and
for each of the M participants,
encrypting the plaintext data of the each of the M participants based on the random numbers and the key information by using a plurality of different encryption methods, to obtain a plurality pieces of first encrypted data;
performing exclusive OR processing on the plurality pieces of first encrypted data to obtain second encrypted data; and
performing desensitization processing on the second encrypted data to obtain the ciphertext data of the each of the M participants.

8. The data processing method of claim 1, wherein the performing of the shard operation on the respective private key information of the M participants comprises:
in response to determining that M is greater than a preset threshold, performing the shard operation on the respective private key information of the M participants.

9. The data processing method of claim 1, wherein the encrypting of the plaintext data of each of the M participants using the key information to obtain the respective ciphertext data of the M participants comprises: in response to determining that M is less than or equal to the preset threshold,
for each of the M participants, multiply-encrypting the plaintext data of the each of the M participants using the respective private key information of the M participants by the M participants in sequence, to obtain the ciphertext data for the each of the M participants.

10. The data processing method of claim 1, further comprising: after performing computation on the respective ciphertext data of the M participants to obtain the data computation result for the M participants,
determining one of the M participants as an anonymous participant; and
anonymizing the data computation result by the anonymous participant.

11. An electronic device, comprising:
a processor; and
a memory storing a computer program executable by the processor to perform operations comprising:
generating respective private key information of M participants, where M is an integer greater than 1;
performing a shard operation on the respective private key information of the M participants according to a predetermined shard operation protocol, to obtain key information;
encrypting plaintext data of each of the M participants using the key information, to obtain respective ciphertext data of the M participants; and
performing computation on the respective ciphertext data of the M participants to obtain a data computation result for the M participants.

12. The electronic device of claim 11, wherein the predetermined shard operation protocol comprises a secure multiplication operation protocol; and
the performing of the shard operation on the respective private key information of the M participants according to the predetermined shard operation protocol to obtain the key information comprises:
performing a secure multiplication operation on the respective private key information of the M participants according to the secure multiplication operation protocol, to obtain respective private key shard products for the M participants; and
determining the key information based on the respective private key shard products for the M participants.

13. The electronic device of claim 12, wherein the performing of the secure multiplication operation on the respective private key information of the M participants to obtain the respective private key shard products for the M participants comprises:
constructing a computation queue of the M participants; and
iteratively performing the following sub-operations on the computation queue until one of the respective private key shard products for last one of the M participants in the computation queue is determined:
extracting first N participants from the computation queue as N first participants, where N is an integer greater than 1 and less than M;
computing a private key shard product for each of the N first participants based on respective private key information of the N first participants; and
selecting one of the N first participants, updating the private key information of the selected one of the N first participants with the private key shard product for each of the N first participants, and adding the selected one of the N first participants to a head of a remaining portion of the computation queue except the N first participants, to update the computation queue.

14. The electronic device of claim 13, wherein the computing of the private key shard product for each of the N first participants based on the respective private key information of the N first participants comprises:
for each of the N first participants, generating an element set comprising at least one element, computing an element shard product, and sharding the private key information of the each of the N first participants to obtain private key shards; and
for each of the N first participants,
obtaining at least one encrypted element, private key shards and blinded private key shards of each one of the N first participants other than the each of the N first participants, wherein the at least one encrypted element is obtained by encrypting the at least one element of the each one of the N first participants using the private key information of the each one of the N first participants, and the blinded private key shards are obtained by binding the private key shards of the each one of the N first participants using the at least one element of the each one of the N first participants; and
computing the private key shard product for the each of the N first participants based on the private key shards, the at least one element and the element shard product of the each of the N first participants, and the at least one encrypted element, the private key shards and the blinded private key shards of the each one of the N first participants.

15. The electronic device of claim 14, wherein the element set comprises at least two elements and a blinding factor; and
the computing of the element shard product of the each of the N first participants comprises:
performing a multiplication operation on the at least two elements of the each of the N first participants and the at least one encrypted element of the each one of the N first participants to obtain a first computation result;
performing a multiplication operation on the at least two elements of the each of the N first participants to obtain a second computation result;
blinding the first computation result using the blinding factor; and
determining the element shard product of the each of the N first participants based on the blinded first computation result and the second computation result.

16. The electronic device of claim 13, wherein the determining of the key information based on the respective private key shard products for the M participants comprises:
taking the one of the respective private key shard products for the last one of the M participants in the computation queue as the key information.

17. The electronic device of claim 11, wherein the encrypting of the plaintext data of each of the M participants by using the key information to obtain the respective ciphertext data of the M participants comprises:
obtaining a key parameter of the key information, wherein the key parameter comprises a plurality of random numbers; and
for each of the M participants,
encrypting the plaintext data of the each of the M participants based on the random numbers and the key information by using a plurality of different encryption methods, to obtain a plurality pieces of first encrypted data;
performing exclusive OR processing on the plurality pieces of first encrypted data to obtain second encrypted data; and
performing desensitization processing on the second encrypted data to obtain the ciphertext data of the each of the M participants.

18. The electronic device of claim 11, wherein the performing of the shard operation on the respective private key information of the M participants comprises:
in response to determining that M is greater than a preset threshold, performing the shard operation on the respective private key information of the M participants.

19. A non-transitory computer-readable storage medium storing a computer program executable by a processor to perform operations comprising:
generating respective private key information of M participants, where M is an integer greater than 1;
performing a shard operation on the respective private key information of the M participants according to a predetermined shard operation protocol, to obtain key information;
encrypting plaintext data of each of the M participants using the key information, to obtain respective ciphertext data of the M participants; and
performing computation on the respective ciphertext data of the M participants to obtain a data computation result for the M participants.

20. A computer program product comprising a computer program executable by a processor to perform the data processing method of claim 1.
